(19) United States
(12) Patent Application Publication
(10) Pub. No.: US 2019/0356574 A1
(43) Pub. Date: Nov. 21, 2019

(54) MOTOR VEHICLE COMPRISING AN INTERNAL DATA NETWORK AND METHOD FOR OPERATING THE MOTOR VEHICLE

(71) Applicant: AUDI AG, Ingolstadt (DE)

(72) Inventor: Elmar SCHOCH, Dachau (DE)

(73) Assignee: AUDI AG, Ingolstadt (DE)

(21) Appl. No.: 16/479,525

(22) PCT Filed: Feb. 8, 2018
(86) PCT No.: PCT/EP2018/053121

§ 371 Date: Jul. 19, 2019

(30) Foreign Application Priority Data
Feb. 9, 2017 (DE) 10 2017 202 022.9

(51) Int. Cl. H04L 12/751; H04L 12/46; H04L 29/06; H04W 4/48

(52) U.S. Cl. CPC H04L 45/10; H04L 12/4641; H04L 2012/40215; H04W 4/48; H04L 63/0236

(57) ABSTRACT

The disclosure relates to a motor vehicle with a vehicle internal data network through which control devices of the motor vehicle are coupled with each other for exchanging messages. The invention provides that the data network is subdivided into a plurality of security zones, within each of which at least one of the control devices is arranged, and domain controllers are provided, each separating at least two of the security zones and adapted to transmit at least one of the messages between at least two of the security zones separate from it if the message meets a predetermined safety criterion and to block the transmission of the message if the safety criterion is violated.

### TECHNICAL FIELD

The application relates to a motor vehicle having an in-vehicle data network by which control devices of the motor vehicle are coupled to each other for exchanging messages. The application also includes a method for operating the in-vehicle data network in the motor vehicle.

### BACKGROUND

In a motor vehicle control devices may be interconnected or coupled by a data network, so that the control devices are operable to exchange messages with each other. By such a message, a measured value or a control command, for example, may be communicated. A message represents at least one data packet which is transmitted by a first of the control devices, the sender, to at least one other control device, a respective addressee or recipient. A message may include one or more data packets. In order to transmit the respective message, the recipient may be indicated therein, for example by specifying an address and an identification number of the receiving control device.

The operation of the motor vehicle may be disturbed or manipulated by a control device due to a defect in the control device or due to an unauthorized manipulation of the control device, in that messages are sent via the defective or manipulated control device to other control devices, which then also change their operating behavior.

From DE 103 19 365 A1 a computer system for a vehicle is known which provides protection against messages that are sent from outside the motor vehicle via the Internet to control devices of the motor vehicle. For this purpose, the data stream incoming from the Internet to the motor vehicle is filtered by a firewall. Between them, control devices are still able to manipulate or interfere with each other.

A driver assistance system is known from DE 10 2013 021 231 A1, which has two microprocessors in order to provide the assistance function through the one microprocessor, while the other microprocessor is used for communication. As a result, protection of the assistance function against manipulation is provided within the control device of the driver assistance system. However, this means that each control device to be protected requires two microprocessors to provide the protection function itself. The data network itself remains unprotected.

From DE 10 2011 007 437 A1 a circuit arrangement for data transmission between processor modules is known. It is described that control devices must be able to meet a certain ASIL (Automotive Safety Integrity Level). There are accordingly control devices which are subject to different safety requirements.

US 2016/0255154 A1 describes a motor vehicle with a data network that may be subdivided into security zones that can be organized in a tree structure. The division into security zones is achieved by the appropriate choice of network topology.

US 2014/0306826 A1 describes a motor vehicle in which devices may be connected to a communication network, wherein each device may be connected to another zone of the communication network depending on the safety requirement. Each zone may be realized by means of a switch of an Ethernet network, wherein the switches and thus the zones are then separated by firewalls.

From the scientific contribution of Malaguti et al. (G. Malaguti, M. Dian, C. Ferraresi, M. Ruggeri, “Comparison on Technological Opportunities for In-Vehicle Ethernet Networks”, Proceedings of INDIN 2013, IEEE International Conference on Industrial Informatics, Vol. 11, 2013, pages 108-115) it is known that in a motor vehicle messages of different priority are distinguishable from each other by being sent in different VLANs.

### BRIEF DESCRIPTION OF THE DRAWINGS

FIG. 1 shows a schematic representation of an embodiment of the motor vehicle according to the application.

### DETAILED DESCRIPTION

The application relates to a motor vehicle having an in-vehicle data network by which control devices of the motor vehicle are coupled to each other for exchanging messages. The application also includes a method for operating the in-vehicle data network in the motor vehicle.

In a motor vehicle control devices may be interconnected or coupled by a data network, so that the control devices are operable to exchange messages with each other. By such a message, a measured value or a control command, for example, may be communicated. A message represents at least one data packet which is transmitted by a first of the control devices, the sender, to at least one other control device, a respective addressee or recipient. A message may include one or more data packets. In order to transmit the respective message, the recipient may be indicated therein, for example by specifying an address and an identification number of the receiving control device.

The operation of the motor vehicle may be disturbed or manipulated by a control device due to a defect in the control device or due to an unauthorized manipulation of the control device, in that messages are sent via the defective or manipulated control device to other control devices, which then also change their operating behavior.

From DE 103 19 365 A1 a computer system for a vehicle is known which provides protection against messages that are sent from outside the motor vehicle via the Internet to control devices of the motor vehicle. For this purpose, the data stream incoming from the Internet to the motor vehicle is filtered by a firewall. Between them, control devices are still able to manipulate or interfere with each other.

A driver assistance system is known from DE 10 2013 021 231 A1, which has two microprocessors in order to provide the assistance function through the one microprocessor, while the other microprocessor is used for communication. As a result, protection of the assistance function against manipulation is provided within the control device of the driver assistance system. However, this means that each control device to be protected requires two microprocessors to provide the protection function itself. The data network itself remains unprotected.

From DE 10 2011 007 437 A1 a circuit arrangement for data transmission between processor modules is known. It is described that control devices must be able to meet a certain ASIL (Automotive Safety Integrity Level). There are accordingly control devices which are subject to different safety requirements.

US 2016/0255154 A1 describes a motor vehicle with a data network that may be subdivided into security zones that can be organized in a tree structure. The division into security zones is achieved by the appropriate choice of network topology.

US 2014/0306826 A1 describes a motor vehicle in which devices may be connected to a communication network, wherein each device may be connected to another zone of the communication network depending on the safety requirement. Each zone may be realized by means of a switch of an Ethernet network, wherein the switches and thus the zones are then separated by firewalls.

From the scientific contribution of Malaguti et al. (G. Malaguti, M. Dian, C. Ferraresi, M. Ruggeri, “Comparison on Technological Opportunities for In-Vehicle Ethernet Networks”, Proceedings of INDIN 2013, IEEE International Conference on Industrial Informatics, Vol. 11, 2013, pages 108-115) it is known that in a motor vehicle messages of different priority are distinguishable from each other by being sent in different VLANs.

It is the object of the application to avoid or prevent the manipulation or disturbance of control devices in a data network of a motor vehicle among themselves.

The object is achieved by the subject-matters of the independent claims. Advantageous developments of the application are described by the dependent claims, the subsequent description and the figure.

The application provides a motor vehicle with an in-vehicle data network. Through the data network, control devices of the motor vehicle are coupled to each other for exchanging messages. “In-vehicle” here means that this is a data network which interlinks the control devices, meaning, it is in particular not primarily a matter of a control device being also coupled to a data source outside the vehicle or off-board of the vehicle, such as a server of the Internet.

In order to mutually protect the control devices, according to the application the data network is divided into a plurality of security zones, within each of which at least one of the control devices is arranged. For example, control devices with the same safety requirement or a group of control devices with predefined safety requirements may be combined in one security zone. A security zone thus represents a segment in the data network to each of which at least one of the control devices is connected. The security zones are separated from each other in the data network but still coupled among each other for conditional message exchange. For this purpose, data controllers or domain controllers are provided, each of which separates at least two of the security zones from each other and on the other hand is adapted to transmit at least one of messages between at least two of the security zones separate from it if the message meets a predetermined safety criterion but which is adapted to block the transmission of the message if the message violates the safety criterion. The separation of the security zones is thus that a message is transmitted between two respective security zones only after a prior control of the message. Thus, a message is not able be spread or distributed arbitrarily in the data network. A message only gets to the end of the security zone in which the message was generated, that is, to the domain controller or to the domain controllers, which separates or separate the security zone from at least one other security zone, respectively. The domain control device checks the safety criterion independently of the sending control device, i.e. detects whether the message is allowed and therefore may be transmitted in at least one other security zone or if the message is inadmissible and thus has to be blocked.

The application provides the advantage that through messaged, a defective or manipulated control device may only reach control devices within its own security zone and that an influence on at least one other of the control devices in at least one other of the security zones is prevented by checking the safety criterion in at least one of the domain controllers.

It is an advantage of the application that at least two of the security zones are only logically separated from each other by realizing each of the logically separated security zones as a VLAN (Virtual Local Area Network). In this way, therefore, a logical segment formation or zone formation may be achieved even when using a common data line for the security zones. This has the advantage that in order to provide a plurality of security zones, it is not necessary to provide a separate data line in each case.

The application also covers developments, the features of which result in additional advantages.

In order to reliably separate security zones from each other, it is preferably provided that at least two of the security zones are physically separated from each other, by each of the physically separate security zones having its own data line. In particular, two security zones based on the same network technology, for example Ethernet, may be physically separated from each other in this way. The physical separation has the advantage that even with knowledge of the MAC address (MAC—Media Access Control) it remains impossible by manipulating the messages to address or reach a control device in physically separated security zones with a manipulated message.

At least one of the control devices preferably has a firewall for separating the security zones to be separated from it and/or a message filter and/or a routing unit for routing the at least one message. A firewall may be realized on the basis of the Internet Protocol (IP) and thus advantageously independently of a message content of the message. Additionally or alternatively, the firewall may provide for monitoring or verifying the service protocol (protocol above the IP in the ISO/OSI reference model) (ISO—International Organization for Standardization; OSI—Open Systems Interconnection). This has the advantage that even such a message is detected as manipulated, which is designed to manipulate operating software of the addressed control device, but it is generated correctly according to the IP. An example of such a message is a so-called stack overflow attack. A message filter is able to distinguish between messages of different classes, for example between a message for notifying a measured value on the one hand and a message for specifying a control command on the other hand. For example, the message filter can pass messages for measured values but block messages with control commands. A message filter is thus able to filter out a message on the basis of a message content or the user data that is exchanged between a respective operating software of two control devices. A routing unit is operable to separate them from each other by providing different message protocols or transmission protocols for the different security zones. The routing unit is operable to then translate a message from a security zone, which is written in a first message protocol, into a second message protocol and forward it in the other security zone. The configuration of a firewall and/or a message filter and/or a routing unit results in each case the safety criterion, by means of which it can be decided whether a message is forwarded or blocked.

A preferred embodiment provides that a tree hierarchy is formed by the security zones, by which in each case at least two of the domain controllers are combined by a respective higher-level domain controller. “Combine” means that the two domain controllers are coupled via the higher-level domain controller and that in order to reach the security zone of one of the domain controllers through a message to be transmitted, both the safety criterion of the higher-level domain controller and the safety criterion of the domain controller itself must be met. This may minimize a number of domain controllers for a given schedule of messages in a motor vehicle a message must pass or pass through or overcome en route from the sending control device to the receiving control device.

By means of the data network according to the application, a data network outside the vehicle or an off-board device may also be integrated. For this purpose, a communication device is preferably set up to couple the data network via a radio link to at least one off-board device and/or an off-board data network and to operate the latter each in its own security zone. The communication device may comprise, for example, a mobile radio module and/or a Bluetooth radio module and/or a WLAN (Wireless Local Area Network) radio module. Accordingly, the respective radio connection may be a mobile radio connection or a Bluetooth connection or a WLAN connection. An off-board device may be, for example, a mobile terminal such as a smartphone or a tablet PC or a smartwatch. Such a mobile terminal may be connected via the radio link to the motor vehicle. An off-board device may also be connected to the data network via a wired communication connection, for example a USB connection (USB—Universal Serial Bus). An off-board data network may be, for example, the Internet or a tunnel connection (VPN—Virtual Private Network) to a server device. Each off-board device and/or off-board data network is separated by providing a separate security zone of the control devices of the motor vehicle by means of at least one domain controller.

A domain controller may, for example, be another control device or a gateway or a router or a switch (network switch). The data network may include at least one of the following network technologies: Ethernet, Controller Area Network (CAN), FlexRay, MOST (Media Oriented Systems Transport). The limits of the respective network technology may be different from the limits of the security zones. In other words, the data network may have hybrid networking, by which at least two different network technologies are combined, wherein in particular at least one security zone may have at least two of the network technologies. As a result, a communication between the two network technologies, that is, transmitting at least one message across the limits of network technologies is possible without being slowed or inefficient, because a domain controller would have to check every message.

As already stated, the safety criterion may be specified or set by a configuration of a firewall or a message filter. The safety criterion preferably additionally or alternatively includes that a sender and/or an addressee of the message to be transmitted coincides with a respective predetermined control device specification. In other words, the message must come from a predetermined sender and/or be addressed to at least one predetermined addressee. Additionally or alternatively, the safety criterion may include that a message type of the message to be transmitted coincides with a predetermined type specification. This has already been written in connection with the distinction between a measured value and a control command. Additionally or alternatively, the safety criterion may include that the message to be transmitted meets a predetermined plausibility condition. For example, a rate or frequency of messages of a given message type may be required within a predetermined value interval. Additionally or alternatively, a message content, for example, a measurement, may be checked to see if it is within a predetermined range.

The motor vehicle according to the application is preferably embodied as a motor vehicle, in particular as a passenger car or truck.

The application also includes a method for operating an in-vehicle data network in a motor vehicle. The data network couples in the described manner control devices of the motor vehicle for exchanging messages with each other. The data network is subdivided into a plurality of security zones within each of which at least one of the control devices is arranged. Domain controllers each keep at least two of the security zones separated from each other by each domain controller transmitting at least one of the messages, respectively, between at least two of the security zones separated by it only if the message meets a predetermined safety criterion, and otherwise blocks transmission of the message if the safety criterion is violated.

The application also includes further developments of the method according to the application, which have features such as those previously described in connection with the further developments of the motor vehicle according to the application. For this reason, the corresponding further developments of the method according to the application are not described herein again.

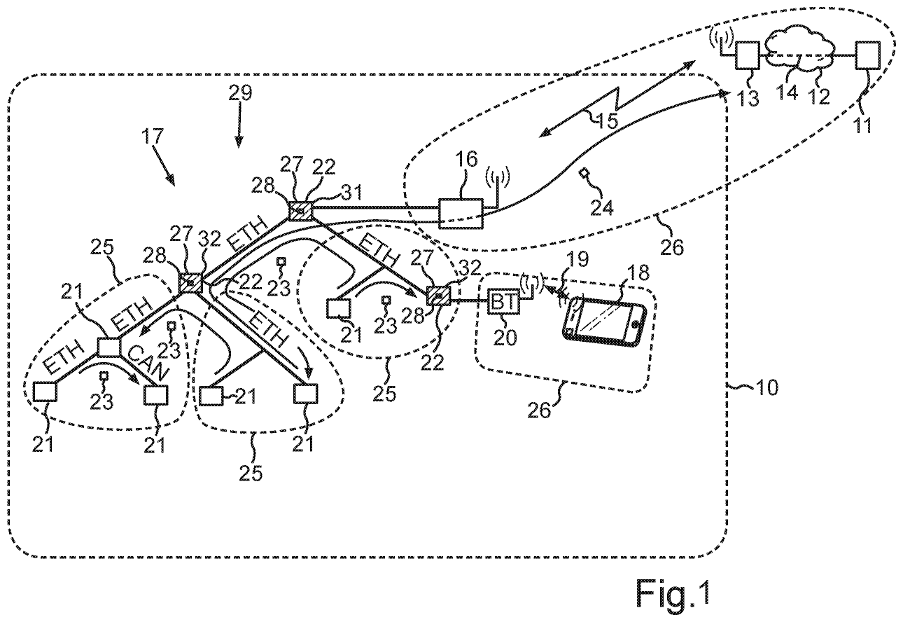

In the following an exemplary embodiment of the invention is described. For this purpose, the one figure (FIG. 1) shows a schematic representation of an embodiment of the motor vehicle according to the application.

The exemplary embodiments explained below are preferred embodiments of the invention. In the exemplary embodiments, the described components of the embodiments each constitute individual features of the application that are to be considered in isolation from one another and each independently develop the application, and so should also be taken as a constituent of the application, even individually or in a different combination from that disclosed. In addition, additional features to those already described may also be added to the described embodiments.

Elements having the same function have been provided with the same reference numerals in the drawings.

FIG. 1 shows a motor vehicle 10, which may be, for example, a motor vehicle, in particular a passenger car or truck. Furthermore, a server device 11, the Internet 12 and a mobile radio network 13 are shown. The server device 11 may be coupled via an Internet connection 14 and a radio connection 15 of the mobile radio network 13 to a communication device 16 of the motor vehicle. Instead of the mobile radio network 13, the radio connection 15 may also be provided, for example, by a WLAN router. The server device 27 may be, for example, a server of the Internet, i.e. a computer or a computer network connected to the Internet.

In the motor vehicle 10, a data network 17 may be provided, which may also comprise several different network technologies, for example an Ethernet ETH and/or a CAN bus CAN.

The server device 11 may be coupled to the data network 17 via the communication device 16. For this purpose, the communication device 16 may be embodied, for example, as a mobile radio module and/or a WLAN radio module.

Furthermore, a mobile terminal 18 may be coupled to the data network 17, for example via a radio connection 19, which may be provided by means of a Bluetooth radio module 20 (BT) of the motor vehicle 10. In addition or as an alternative to the radio connection 19, a wired communication connection, e. g. for a USB connection (not shown), may also be provided, for example. The terminal 18 may be, for example, a smartphone and/or a tablet PC or a smartwatch.

Within the data network 17 of the motor vehicle 10, control devices 21 may be interconnected or coupled to each other for exchanging messages 23 by data lines and/or radio links. At least one or some of the control devices 21 may also exchange messages 24 with the server device 11 and/or the terminal 16, respectively. A control device 21 may be, for example, an engine control device or a seat control device or an infotainment control device (infotainment-information-entertainment) or an ESC control device (ESC—electronic stability control), respectively.

Depending on the control device 21, a manipulation of the control device 21, which affects the operation of the control device 21, may have different effects on the driving safety of the motor vehicle 10. Such a manipulation may be caused, for example, by a manipulated message 23, 24 or by an uncontrolled sending of such messages 23, 24 by a defective other control device (e.g. so-called “Babbling Idiot”).

In the motor vehicle 10, the control devices 21 may be subdivided into different groups depending on the need for protection, which in turn are separated from each other by safety measures.

For this purpose, the data network 17 may be divided or subdivided into security zones 25, 26. Despite control devices 21 which are closely networked with each other and with the outside world, the security zones 25, 26 are able to block or prevent an uncontrolled or unverified transmission of messages 23, 24 between control devices 21 of different security zones 25, 26 within the in-vehicle, hybrid interconnection. For this purpose, the security zones 25, 26 represent a physical and/or logical segment formation or zone formation, wherein in each security zone 25, 26 control devices 21 of a similar degree of importance or requiring a similar level of security, for example, as measured on the basis of the ASIL, may be combined. For example, control devices 21 with the same ASIL may be combined.

The security zones 25, 26 may be separated from each other by a domain controller 27, respectively. Each domain controller 27 may be provided or implemented by a control device 22, for example. Such a domain controller 27 may provide for example, a firewall and/or protocol translation or protocol implementation, respectively, on one or more or all protocol layers according to the ISO/OSI reference model between two security zones 25, 26. For the logical separation, VLANs, for example, may be used for Ethernet networks ETH in combination with IP and service protocol firewalls (service protocol: protocol above the IP protocol in the ISO/OSI reference model).

A security zone 26 to an off-board device, such as the server device 11, may be formed, for example, on the basis of a secure tunnel, for example, a VPN. A connection of the mobile terminal 18 may also be separated or isolated from the remaining security zones 25 of the data network 17 by a domain controller 27 as its own security zone 26.

The respective configuration of a firewall and/or protocol implementation results in a safety criterion 28 for each domain controller 27, on the basis of which a message 23 to be transmitted between two security zones 25, 26 by the domain controller 27 may be checked to see whether the message 23, 24 should be transmitted or blocked by the domain controller 27.

The representation of the data network 17 in FIG. 1 illustrates how, by the arrangement of the domain controllers 27 in the data network 17, the latter may have a tree hierarchy 29. One of the domain controllers 27 may represent the root 31 of the tree hierarchy 30, from which other domain controllers 27 may each represent a node 32 in the tree hierarchy 30.

In the motor vehicle 10, the security zones 25, 26 may increase safety through a consistent safety architecture between electrical and/or electronic control devices 21. In this case, an off-board server device 11 may advantageously also be integrated.

Overall, the examples show how security zones in the hardware and software architecture of a motor vehicle may be provided by the application.

1.-9. (canceled)

10. A motor vehicle comprising an in-vehicle data network that is subdivided into a first security zone and a second security zone, the in-vehicle data network comprising:
a first control device assigned to the first security zone;
a second control device assigned to the second security zone, each of the first and second control device configured to exchange messages with other coupled control devices;
a domain controller configured to:
logically separate the first and second security zones from each other by realizing the first and second security zones as a virtual local area network (VLAN) having a common data line;
allow transmission of a message between the first and second security zones if the message fulfills a predetermined safety criterion, wherein the predetermined safety criterion is one of: a sender or an addressee of the message coincides with a respective predetermined control device specification, or a message type of the message coincides with a predetermined type specification, or a predetermined plausibility condition of the message is satisfied; and
block the transmission of the message between the first and the second security zones if the message does not fulfill the predetermined safety criterion.

11. The motor vehicle according to claim 10, the in-vehicle data network further including a third security zone and a fourth security zone, wherein the third and the fourth security zones are physically separated from each other by each having its own data line.

12. The motor vehicle according to claim 10, wherein the domain controller has a firewall or a message filter or a routing unit for routing the message.

13. The motor vehicle according to claim 10, wherein the in-vehicle data network further comprises a second domain controller and a higher-level domain controller, wherein the higher-level domain controller combines the domain controller and the second domain controller in a tree hierarchy within the in-vehicle data network.

14. The motor vehicle according to claim 10, wherein the in-vehicle data network further comprises a communication device that connects, via a radio link or a wired communication link, with an off-board device or an off-board data network.

15. The motor vehicle according to claim 10, wherein the in-vehicle data network is further configured to use at least one of the following network technologies: Ethernet (ETH), Controller Area Network (CAN), FlexRay, and Media Oriented Systems Transport (MOST).

16. The motor vehicle according to claim 10, wherein the in-vehicle data network further comprises a hybrid network that combines ETH and CAN technologies in one security zone.

17. A method for operating an in-vehicle data network in a motor vehicle, wherein the in-vehicle data network is subdivided into a first security zone and a security zone, the method comprising:
exchanging, by a first control device assigned to the first security zone, a message with the second control device;
logically separating, by a domain controller, the first and second security zones from each other by realizing the first and second security zones as a virtual local area network (VLAN) having a common data line;
wherein the exchanging further comprises allowing, by the domain controller, transmission of the message between the first and second security zones if the message fulfills a predetermined safety criterion, wherein the predetermined safety creiterion is one of: a sender or an addressee of the message coincides with a respective predetermined control device specification, or a message type of the message coincides with a predetermined type specification or a predetermined plausibility condition of the message is satisfied; and
wherein the exchanging further comprises blocking, by the domain controller, the transmission of the message between the first and the second security zones if the message does not fulfill the predetermined safety criterion.
